(19) United States
(12) Patent Application Publication
(10) Pub. No.: US 2025/0140504 A1
(43) Pub. Date: May 1, 2025

(54) IN-LINE FUSE HOLDER

(71) Applicant: Bahram Sobbi, Calgary (CA)

(72) Inventor: Bahram Sobbi, Calgary (CA)

(21) Appl. No.: 18/837,287

(22) PCT Filed: Feb. 13, 2023
(86) PCT No.: PCT/IB2023/051282

§ 371 Date: Aug. 9, 2024

Related U.S. Application Data
(60) Provisional application No. 63/310,157, filed on Feb. 15, 2022.

(51) Int. Cl. H01H 85/20; H01H 85/32

(52) U.S. Cl. CPC H01H 85/2015; H01H 85/203; H01H 85/32; H01H 2223/002

(57) ABSTRACT

An in-line fuse holder has quick connect electrical connectors for electrically connecting wires with a fuse held by the holder. The quick connect electrical connectors allow connecting the wires without splicing the wires or attaching electrical connectors to the ends of the wires.

### FIELD OF THE INVENTION

The present disclosure relates to fuse holders and, more particularly, to an in-line fuse holder having quick connect electrical connector terminals for electrically connecting wires to the electrical contacts of the fuse holder.

### BACKGROUND OF THE INVENTION

Fuses are commonly used in electric circuits to provide overload protection to circuits and devices connected to the circuit. When electrical accessories are installed

in vehicles, it is common to use an in-line fuse holder along the power supply line of the accessory to provide overload protection by a fuse held by the fuse holder.

While operating to provide overload protection, existing in-line fuse holders suffer from several drawbacks. For example, existing in-line fuse holders are typically provided with wires that are permanently attached to the fuse holder's electric

contacts. Connecting this fuse holder to the electrical circuit requires using electrical connectors (i.e., butt connectors) and related specialty tools to secure and splice the ends of the fuse holder wires to the electrical circuit, which is typically the power lead. These splice connections are time-consuming, introduce possible points of failure in the electrical circuit, and require using heat shrink tubing to reduce or
prevent water intrusion or inadvertent electrical contact at the splice connections. The permanently attached wires of this style fuse holder also make removal of the fuse holder problematic because it requires cutting the wires, which results in shortening the wires and making the fuse holder less usable and is some cases unusable.

Other existing in-line fuse holders eliminate the permanently attached wires 30 and use terminals for securing the circuit wires to the fuse holder electric contacts. These typical terminals include some threaded posts and nuts for securing a wire to the terminal. To properly secure a wire to such a terminal requires connecting an appropriate electrical connector (i.e., a ring terminal or spade terminal) to the end of the wire for engagement with the fuse terminal. Again, requires specialty tools to

attach the electrical connectors to the wire ends. Further, these connections are time-consuming, introduce possible points of failure in the electrical circuit, and require
using heat shrink tubing to reduce or prevent water intrusion or inadvertent electrical contact at the connections.

Accordingly, there is a need and desire to have a new in-line fuse holder that overcomes the foregoing described and other drawbacks with existing in-line fuse holders.

### SUMMARY OF THE INVENTION

Embodiments of the invention provide an in-line fuse holder that overcomes the drawbacks of existing in-line fuse holders by having quick connect electrical connectors for electrically connecting wires to the fuse holder's electric contacts.

The quick connect electrical connectors allow connecting wires to the fuse holder electric contacts directly without attaching electrical connectors to the ends of the wires. This eliminates the need for specialty tools, reduces complexity and time to install, and eliminates possible failure points. Further, the quick connect electrical connectors allow the wires to be disconnected from the fuse holder without needing to be cut.

Numerous additional objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being

practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide a further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature or a feature with similar functionality. In the drawings:

FIG. 1 a perspective view of an in-line fuse holder that is constructed in accordance with an embodiment of the invention;

FIG. 2 is a side view of a body of an in-line fuse holder that is in accordance with an embodiment of the invention;

FIG. 3 is a perspective view of a cover of an in-line fuse holder that is constructed in accordance with an embodiment of the invention;

FIG. 4 is a top view of a body of an in-line fuse holder that is constructed in accordance with an embodiment of the invention;

FIG. 5 is a side view of a body and fuse of an in-line fuse holder that is constructed in accordance with an embodiment of the invention; and

FIG. 6 is a bottom view of a body of an in-line fuse holder that is constructed in accordance with an embodiment of the invention.

### DETAILED DESCRIPTION

The following detailed description of embodiments of the invention references the accompanying drawings. The embodiments are intended to describe aspects of the

invention in sufficient detail to enable those skilled in the art to practice the invention. Other embodiments can be utilized, and changes can be made without departing from the scope of the disclosure.

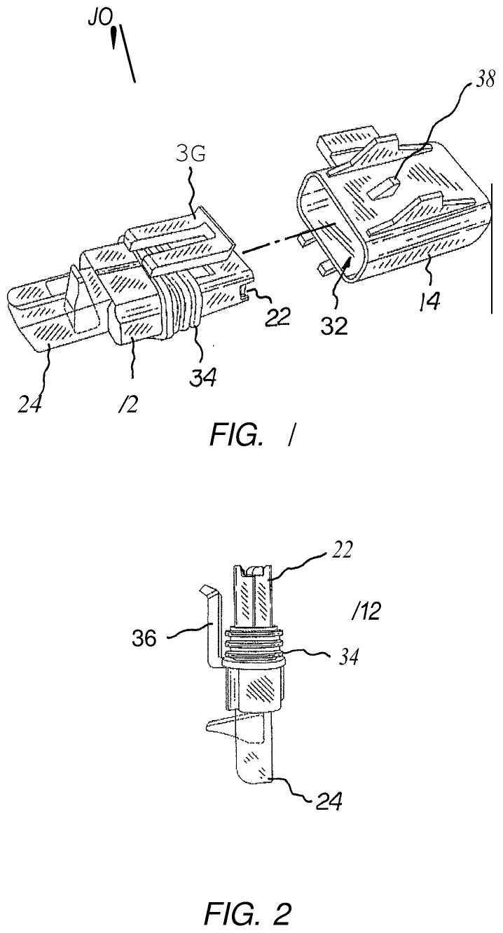

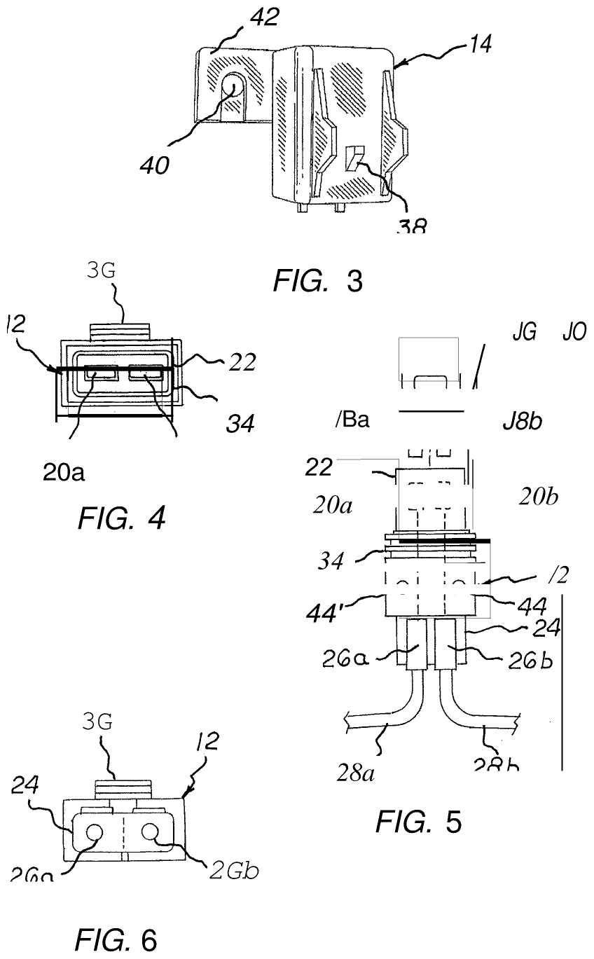

Turning now to FIGS. 1-6 of the drawings, an in-line fuse holder 10 constructed in accordance with an embodiment of the invention is illustrated. The fuse

holder 10 includes a body 12 and a lid or cover 14. The body 12 and the cover 14 can be molded pieces and formed of a rigid, insulative plastic or like material.

Fuse holder 10 holds a fuse 16. Fuse 16 is illustrated as a typical blade fuse such as, for example an ATM, ATC, and/or ATO fuse, which is commonly used in automotive applications. Typically, fuse 16 has a pair of metal contact blades 18a and 18b that extend from the fuse.

Body 12, in the illustrated embodiment, has a pair of electrical contacts 20a and 20b that are located at end 22 of the body and held by the body. Electrical contacts 20a and 20b are configured to removably receive the contact blades 18a and 18b in a snug, friction fit, in a push-in and pull-out motion.

Further, in the illustrated embodiment, end 24 of body 12 includes quick connect electrical terminals 26a and 26b for receiving the ends of wires 28a and 28b via openings 30a and 30b. The quick connect electrical terminals 26a and 26b are electrically connected to electrical contacts 20a and 20b, respectively. And operate to secure the ends of wires 28a and 28b with body 12 and electrically connect the wires to electric contacts 20a and 20b, and thus the fuse 16.

The quick connect electrical terminals 26a and 26b could be the electrical connectors and/or terminals shown in described in U.S. Pat. No. 4,541,679 and/or shown and described in U.S. Pat. No. 6,238,233, the disclosures of both being incorporated herein in their entirety. One of ordinary skill in the art will appreciate that other quick connect electrical connectors could also be used, as such the invention is not limited solely to the electrical connectors and/or terminals shown and disclosed by these two patents.

Cover 14 has a receptacle 32 that is configured to removably receive therein end 22 of the body 12 with fuse 16 and completely enclose the fuse. A rubber seal 34 of the like can be disposed on body 12. Seal 34 is configured to make sealing contact with cover 14 when end 22 is inserted into receptacle 32, thereby creating a sealed enclosure that prevents water contact with fuse 16 and electric contacts 20a and 20b. Body 12 may have a resilient clip 36 that engages with a tab 38 on the cover

14 to securely couple the body and cover. Lifting outwardly on clip 36 allows it to disengage with tab 38 and permits disconnecting the body 12 and cover 14.

Cover 14 may include a hole or aperture 40, representatively formed through tab 42, for attaching or mounting the cover to a desired support surface using a threaded fastener.

The fuse holder 10 may include one or more LED lights 44 that are operatively connected to one or more of electrical contacts 20a and 20b to indicate the

operation of the electrical circuit and status of the fuse 16. For example, an LED light could indicate whether fuse 16 is intact or blown and an LED light could indicate whether one of the wires 28a or 28b has power from a connected power source.

It will be appreciated by persons skilled in the art that the present embodiment is not limited to what has been particularly shown and described hereinabove. A

IO variety of modifications and variations are possible in light of the above teachings without departing from the scope of the disclosure.

What is claimed is:

1. An in-line fuse holder for a fuse comprising:
a body having a first end and an opposite second end;
first and second electrical contacts disposed on the first end, each configured to receive and grip a blade of a blade fuse;
first and second quick-connect electrical terminals disposed on the second end, each configured to receive an end of a wire and electrically connect the wire to a respective one of the first and second electrical contacts;
a cover having a receptacle through a first end thereof in which the first end of the body is removably receivable to enclose a fuse connected to the first and second electrical contacts;
a seal disposed on the body for creating a sealing contact with the cover when the first end is received in the receptacle, thereby creating a sealed enclosure that
prevents water contact with the fuse and the first and second electrical contacts; a mounting tab extending from the cover and a hole formed through the
mounting tab;
a resilient clip disposed on the body; and
a tab disposed on the cover, wherein the resilient clip is engageable with the tab to secure the body and cover together.

2. The in-line fuse holder of claim 1, further comprising:
a seal disposed on the body for creating a sealing contact with the cover when the first end is received in the receptacle, thereby creating a sealed enclosure that
prevents water contact with the fuse and the first and second electrical contacts.

3. The in-line fuse holder of claim 1, further comprising:
a mounting tab extending from the cover and a hole formed through the mounting tab.

4. The in-line fuse holder of claim 1, further
comprising: a resilient clip disposed on the body; and
a tab disposed on the cover, wherein the resilient clip is engageable with the tab to secure the body and cover together.

5. The in-line fuse holder of claim 1, further comprising:
one or more LED indicators disposed on the body and electrically connected to one or both of the first and second electrical contacts and configured to be energized to indicate a status of a fuse connected to the first and second electrical contacts.

6. An in-line fuse holder for a fuse comprising:
a body having a first end and an opposite second end;
first and second electrical contacts disposed on the first end, each configured to receive and grip a blade of a blade fuse;
first and second quick-connect electrical terminals disposed on the second end, each configured to receive an end of a wire and electrically connect the wire to a respective one of the first and second electrical contacts;
a cover having a receptacle through a first end thereof in which the first end of the body is removably receivable to enclose a fuse connected to the first and second electrical contacts;
a seal disposed on the body for creating a sealing contact with the cover when the first end is received in the receptacle, thereby creating a sealed enclosure that prevents water contact with the fuse and the first and second electrical contacts;
a mounting tab extending from the cover and a hole formed through the mounting tab;
a resilient clip disposed on the body;
a tab disposed on the cover, wherein the resilient clip is engageable with the tab to secure the body and cover together; and
one or more LED indicators disposed on the body and electrically connected to one or both of the first and second electrical contacts and configured to be energized to indicate a status of a fuse connected to the first and second electrical
contacts.
